(19) United States
(12) Patent Application Publication
(10) Pub. No.: US 2005/0250375 A1
(43) Pub. Date: Nov. 10, 2005

(54) Universal electrical plug and socket

(76) Inventor: Brian Allison, Vancouver, WA (US)

Correspondence Address: Robert Ireland;Ireland at Law, PO Box 273, Banks, OR, 97106, US

(21) Appl. No.: 11/056,623

(22) Filed: Feb. 14, 2005

Related U.S. Application Data
(60) Provisional application No. 60/569,160, filed on May 10, 2004.

(51) Int. Cl. H01R 11/00

(52) U.S. Cl. 439/502

(57) ABSTRACT

A socket and plug assembly, comprising a socket member including a housing that confines a plug receiver space and defining an axial direction, said socket member further including a socket face plate internal to the housing and perpendicular to the axial direction defining the depth of the plug receiver space, further including at least four conductive prongs mounted through and projecting outwardly from said socket face into said plug receiver space, said conductive prongs also extending oppositely in the axial direction through the non-conductive housing, said conductive prong ends extending out through said non-conducting housing permitting electrical connection to an electrical device; and a plug member fittingly insertable into said receiver space of said mated socket member, including a non-conducting plug case having a plug face side and a power cord side, further including at least four prong cavities open on the plug face side being in spatial communication with the number, fit, and configuration of said conductive prongs protruding from said socket face plate, including one or more internal conductive terminals captively connected within said prong cavities, said internal conductive terminals being conductively exposed inside the prong cavities, constructed and arranged to induce electrical connection with said conductive prongs when said conductive prongs are received into said prong cavities, said internal conductive terminals projecting outwardly from the non-conducting plug case along the axial direction on the power cord side permitting electrical connection between the internal conductive terminals and a power cord.

### CROSS REFERENCES TO RELATED APPLICATIONS

Provisional Patent Application filed on May 10, 2004, application No. 60/569,160.

### STATEMENT REGARDING FEDERALLY SPONSORED RESEARCH OR DEVELOPMENT

This invention is not the product of any Federally Sponsored Research or Development.

### REFERENCE TO MICROFICHE APPENDIX

Not Applicable

### TECHNICAL FIELD

The invention relates to a multi-prong Electrical Plug and Socket, for use in electrically interconnecting appliances, lighting fixtures, and electrical tools, to various voltages and wall socket configurations including 120VAC and 240VAC. Connecting electrical devices to electrical service is well known in the art. Most well known methods involve a power cord plugging into an outlet, the other end of the power cord hardwired to the device. If the outlet voltage is different than what the electrical device is hardwired for, a voltage adapter or power converter must be employed between the electrical device and power service to raise, lower, or condition the voltage accordingly. Some manufacturers ship the electrical appliance with two power cords along with instructions, requiring the end user to hardwire the power cord to match the available outlet voltage. The present invention connects the electrical device to electrical service via a plug and socket, wherein the socket is pre-hardwired to the electrical device, and the plug is hard wired to a power cord matching the available service voltage and wall outlet configuration. In one embodiment, a remote ballast assembly for HID lighting would have the socket mounted to the external housing, pre-hardwired to the internal components, having two power cord options, each with a mated plug to the socket on one end, and on the other end having either a 120VAC wall outlet plug or a 240VAC wall outlet plug. The Universal Electrical Plug and Socket has utility by simply, inexpensively, reliably, and safely connecting various power services to any appliance, tool or electrical device.

### BACKGROUND OF THE INVENTION

Typical residential dwellings and industrial locations receive both 120VAC and 240VAC electrical service. The electrical power is delivered using three conductor legs. The three conductor 120VAC electrical service usually has a “Common Leg”, a “Hot Leg” and a “Ground Leg”, having zero voltage differential between the “Common Leg” and the “Ground Leg”, 120VAC voltage differential between the “Hot Leg” and the “Common Leg”, and 120VAC voltage differential between the “Hot Leg” and the “Ground Leg”. The three conductor 240VAC electrical service usually has a “Common Leg”, a “Hot Leg” and a “Ground Leg” similar to the 120VAC service but having 120VAC voltage differential between the “Common Leg” and the “Ground Leg”, 240VAC voltage differential between the “Hot Leg” and the “Common Leg”, and 120VAC voltage differential between the “Hot Leg” and the “Ground Leg”. The 240VAC voltage differential between the “Hot Leg” and the “Common Leg” is accomplished by having two 120VAC legs being 180 degrees out of phase.

High Intensity Discharge [HID] lighting fixtures, welders, and plasma cutters commonly operate on a power supply of 240VAC. These electrical devices can also operate on a power supply of 120VAC. Due to the dual power supply option, manufacturers produce both 240VAC and 120VAC devices that are substantially similar, excepting the service power voltage and outlet wall socket configuration. The immediate consequence of having both 120VAC and 240VAC product lines for the same end application, is a double inventory problem for the retailer. The retailer is forced to carry both the 120VAC and the 240VAC products.

To accommodate both 120VAC and 240VAC service, and avoid the double inventory problem for the retailer, some manufacturers ship their electrical devices with a 240VAC cord, and a 120VAC cord, requiring the end user to hardwire the device for the desired source voltage. If the end use fails to properly hardwire the power cord, the electrical devices could terminally fail causing serious harm to the operator and/or property.

When electrical devices are shipped pre-hardwired for a single voltage, and the available service voltage does not match the pre-hardwired configuration, the end user would be forced to employ a voltage adapter transformer or a power converter, to condition the service voltage according to the electrical device requirements. External voltage adapter transformers and power converters carry additional expense, are plagued with parasitic losses, generate heat, and waste available space.

One other method for achieving service voltage versatility is the employment of a voltage selector switch hardwired to the electrical device. For example, for an electrical device having an internal transformer with wiring taps for “Common”, “Ground”, “120VAC” and “240VAC”, the voltage selector switch allows the end user to simply flip a switch to select between three conductor wire 120VAC or 240VAC electrical service. The switch would be in the “first conducting” position when selecting service voltage of 120VAC, connecting the “Hot Leg” to the 120VAC tap on the internal transformer. When switched to the 240VAC option, the voltage selector switch would be in the “second conducting” position connecting the “Hot Leg” to the 240VAC tap on the internal transformer. The “Ground Leg” would remain constant regardless of the selector switch position being wired to the “Ground” on the internal transformer. The “Common” tap would also remain constant as far as electrical connection being wired to the “Common Leg”, however, in the case of switching from 120VAC service voltage to 240VAC service voltage, the wall socket “Common Leg”” conductor wire changes in voltage potential from the “Ground Leg” to 120VAC, being 180 degrees out of phase with the “Hot Leg”. In short, the switch changes the “Hot Leg” between the 120VAC tap and the 240VAC tap on the internal transformer, while the “Common” tap remains the same in both configurations, only changing in voltage potential from the “Ground Leg” from 0VAC to 120VAC.

Regarding the above example where the electrical device had an internal transformer and selector switch, the switch would be hardwired in series between the “Hot Leg” and the 120VAC tap and the 240VAC tap of the transformer located internal to the appliance or electrical device. The “in rush” current passing through the switch upon start up of some appliances and electrical devices could cause failure of the switch due to the inherent resistance and impedence characteristic of the switch itself. The selector switch would simply break down under extreme draws upon start up, even if used correctly. If the selector switch was used incorrectly and the selector switch was in the 120VAC position, but the actual service voltage was 240VAC, device failure could be immediate and catastrophic. When you apply 240V on 120V input primary tap you are pushing too much voltage through the primary coil wire, hence, the wire material may fail creating a short either between layers of the coil wire on the primary or shorting a wire to the internal transformer's steel core. The internal transformer could have an open circuit condition, and as a consequence, this scenario could create excessive heat, smoke and/or fire in the internal transformer. If the internal transformer catches fire, then the entire fixture could be inflamed. The overvoltage scenario is extremely dangerous, and the entire fixture can become very volatile. Hence, it is extremely important to prevent overvoltage condition when ballast leads are wired to the fixture.

During the endeavor to overcome this flawed selector switch, the present invention was conceived and developed. By replacing the switch with the four conductor socket hard wired to the electrical device, and utilizing the matching four conductor power cords that removably engage and interlock with the four conductor socket, the selection of service voltage is performed by selecting the power cord, not by flipping the switch.

The four conductor power cords are constructed to prevent any selection of voltage not matching the actual service voltage. It is commonly known and understood that 240 VAC service voltage wall outlet sockets have different conductor prong configurations than does the 120VAC service voltage wall outlet sockets. The 120VAC power cord has the matching 120VAC prong configuration. The 240VAC power cord has the matching 240VAC prong configurations. By making the switch between voltages via power cord selection, the end user is prevented from making an error. The power cord prongs will only fit into the wall socket having the correct service voltage that the power cord is constructed and arranged to carry to the electrical device.

One advantageous aspect of the present invention, is that the universal socket is hardwired to the electrical device, and the universal plug power cord is selected to match the various service voltages and wall socket configurations. In the United States, the most common electrical services are 120VAC and 240VAC, carried on three conductors, the “Ground Leg”, the “Common Leg” and the “Hot Leg. A four conductor prong configuration of the present invention readily allows for the most common voltages to be adapted to, however, the 120VAC and 240VAC embodiments described herein shall not limit the scope of this invention to other service voltages and/or conductor configurations.

To illustrate the 120VAC/240VAC four conductor prong embodiment, assume an electrical device has an internal transformer with four taps, “Common”, “Ground”, “120VAC” and “240VAC”, the four conductor prong socket would have one conductor prong electrically connected to each internal transformer tap. The matching universal plug removable engages with the four prong universal socket, causing electrical conduction in three out of the four universal socket prongs. One critical aspect of this invention is that the number of conductor prongs of the socket must always be one more than the service voltage. Illustrating this point, when configured for 120VAC service voltage, the “Hot Leg” is connected to the “120VAC” tap via electrical connection at the universal plug and universal socket, leaving the “240VAC” tap unconnected, ungrounded, and open. When configured for 240VAC service voltage, the “Hot Leg” is connected to the “240VAC” tap via electrical connection of the universal plug and universal socket, leaving the “120VAC” tap unconnected, ungrounded, and open. The “Ground Leg” and “Common Leg” are electrically connected via the universal plug and socket to the “Ground” and “Common” taps of the internal transformer, exactly the same for either 120VAC or 240VAC service. Due to the circumstance that the universal plug is hard wired to the power cords, power cord selection dictates service voltage selection, eliminating the need for a voltage selection switch or any external power converter.

Other companies have recently delivered to market new products that address the challenge of accommodating both 120VAC and 240VAC electrical service voltages. Hydrofarm, a horticulture light manufacturer developed and brought to market in January of 2005 the XTRASUN. The XTRASUN utilizes two sockets, one for 240V and one for 120V, with a switchable plate between the two voltages. The XTRASUN suffers from a major flaw in that the end user could plug the power cord into the wrong socket causing catastrophic failure due to fact that the same plug will fit into either socket. Another flaw with the XTRASUN system is that the plate could be positioned in a horizontal position allowing the end user to plug the power cord into either socket or both sockets at the same time, again, causing catastrophic failure. Further problems with the system is that if the plate is in the horizontal position and the system is energized, the unused socket is “Hot”, and the exposed prongs carry a dangerous voltage differential. The present invention demonstrating the 120VAC/240VAC embodiment utilizes one socket having four conductors performing the same task as the XTRASUN dual socket system. Both service voltages, 120VAC and 240VAC, have three conductors delivering power service with only one “leg” being different. The four conductor universal socket allows for ready conversion between the 120VAC and 240VAC voltages by simply leaving one conductor unused in each configuration and changing the wiring pattern of the power cord between the universal plug and wall socket plug. The present invention does not suffer the end user vulnerabilities of the XTRASUN, due mostly to the unique power cord construction capturing the universal plug, properly configured to a 120VAC or 240VAC wall socket plug, preventing the end user from plugging the wrong power cord into the wrong service voltage. Short of physically removing the wall socket plug and changing the wiring, the present invention is fool proof Also, the universal plug and universal socket enjoy a unique shape different from all other standard power cords and socket receptacles, further preventing end user error. The only socket that the universal plug will fittingly insert into is the universal socket mated to the desired configuration.

The present invention allows production of an electrical device or appliance featuring a common universal socket, receiving of multiple universal plug power cords, allowing for connection to multiple power service voltages and outlet wall socket configurations. The only duplicative inventory requirements are the inexpensive universal plug power cords. The safety hazard of having the end user wire the power cord directly to the appliance is eliminated, as is the hazard of the end user selecting the power service voltage via a switch. The present invention's failure rate and safety characteristics will match that of the standard power cord. Connecting the universal plug into the universal socket is as easy as plugging any other power cord into a wall socket. The universal plug comes pre-fabricated in the power cord assembly and configured for the power service voltage matching the wall socket receptacle plug on the other end. The design is simple, economical, and significantly improves the marketability of any electrical device or appliance that can operate on multiple power service voltages.

### DISCLOSURE OF RELATED ART

As disclosed in U.S. Pat. No. 2,323,736, there is shown a three-prong plug in which the ground prong is capable of being retracted from a position of use, depending on whether or not 3-wire electrical outlet is encountered. The plug discloses in '736 is the “end plug” or the plug on the end of the power cord. When retracted for use with a 2-wire outlet, however, this leaves the electrical device with which the plug is associated ungrounded. One immediate difference between '736 and the present invention is that the universal plug and socket acts as an intermediary connection between the power cord, and the electrical device. The three-prong plug patents included herein are included to provide some historical context as to the problem and previous solutions in adapting to different voltages and different electrical service outlet configurations.

U.S. Pat. Nos. 2,876,426 and 2,922,134 disclose electrical connecting plugs in which a pivotable grounding element is provided. The ground prong on encountering the 2-wire outlet is pivoted so that the finger portion of the grounding prong is out of position so that the connecting plug can be used. In U.S. Pat. No. 2,876,426, the other end of the pivoted prong is constructed so that the prong being pivoted, it is in contact with the grounded receptacle plate and, in turn grounds the electrical device. These adaptations to different wall outlet or extension cord receptacles do not facilitate a voltage change, only the mechanical connection between the receptacle and the power plug. The present invention can advantage the use of any electrical connecting plug that fits the wall socket and also adapt to either 120VAC or 240VAC because of the unique four prong intermediary connection between the appliance and service voltage.

U.S. Pat. No. 3,134,631 discloses another three-prong electrical plug in which the ground prong is pivotable out of position in case the plug used with a 2-wire electrical outlet. The ground prong is provided with a groove adjacent its free and for insertion of a ground wire which in turn can be connected to a ground lead in the electrical outlet. A further electrical plug which is provided piotable prong is disclosed in U.S. Pat. No. 3,178,667. When a 2-wire outlet in encountered, the pivotable ground prong therein is resiliently urged against the faceplate of the receptacle to establish a ground, thereby reducing the possibility of a shock being transmitted to the user of an electrical device. The reduction in any hazard is extremely desirable in connecting power to an appliance. The present invention is completely encased in non-conducting material without any conducting prongs exposed. The end user employs the universal plug into the universal socket just as one would plug a power cord into a wall outlet. There are no “hot” conductors that could come into contact with an end user. Also, there is no wiring, screwing, or flipping of switches when using the present invention, thus reducing user error in installing the universal plug and socket.

U.S. Pat. No. 2,984,808 discloses another three-prong convertible plug in which the ground plug can be pivoted into the use position, or not, depending on the electrical service outlet. A “pig-tail” connection is provided on the plug, and in connection with the ground, for connection to the ground screw of a 2-wire receptacle. Another three-prong-plug in which a pivotable ground prong is provided is disclosed in U.S. Pat. No. 2,986,718. A “pig-tail” is provided with a connection at the other end for connection to the ground screw in circumstance of the use with a 2-wire electrical outlet. These three prong plug patents all attempt to adapt from various service voltages and different service outlet configurations using an adapter plug on the terminal end of the power cord. The present invention provides for an intermediary four prong electrical connection between the appliance and the wall outlet, electrical and mechanical connection occurring at the universal socket and plug. The universal four prong socket does not change configuration as to the appliance or electrical device when adapting to different voltages. The adaptation is facilitated in the wiring of the power cord and the selection of the terminal end. This adaptation by power cord could not be accomplished without the unique four prong plug socket and plug. For example, a power cord wired for 120VAC will use three prongs for conductivity at the socket and plug junction. When a power cord is wired for 240VAC, three prongs are used for conductivity, but not the same three. This allows the socket to remain the same in the wiring configuration to the appliance, but two power cord options having one power cord wired for 120VAC and the other wired for 240VAC, both power cords having universal four prong plugs on one end, and the terminal end having the service voltage plug receptacle. Once significant advantage of the universal socket and plug is that the four prong configuration allows for adaptation to many different voltages and service receptacle connections.

The use of transformers is known in the prior art to increase or decrease the service voltage according to device voltage requirements. For example, U.S. Pat. No. 6,108,226, Ghosh, et. al, discloses a transformer and method to detect line conditions for service voltage, and then condition to the required input voltage. However, the Ghosh '226 patent must use a transformer and uses multiple electrical devices to accomplish the service voltage conditioning. The present invention performs the same task with a simple power cord selection that is inexpensive, safe, and extremely reliable.

U.S. Pat. No. 2,664,128 to Henrich discloses a regulator that changes the phase of any auxiliary voltage. However, the Henrich '128 patent does require two transformers causing parasitic losses and additional expense. The present invention accomplishes the same task in selecting between 120VAC or 240VAC service voltage, by simply changing power cords.

U.S. Pat. No. 5,159,545 to Lee discloses an adapter that has multiple plug sets for different national power supplies. However, the Lee '545 patent requires the use of an external transformer or converter between the electrical service and the electrical device. The '545 patent also employs a selector switch that would also be prone to failure during high “in rush” currents during start up of certain electrical devices.

Similarly, U.S. Pat. No. 5,589,760 to Lee discloses a voltage converter that automatically switches between power service to match the desired input 110 VAC voltage requirements of the device. However, the Lee '760 patent still relies on a selector switch and other electrical components to accomplish the power voltage conditioning increasing expense and failure rates. The '760 patent also is susceptible to the “in rush” current problem during start up of certain electrical devices that would increase the failure rate of the switch and supporting electrical components.

Similarly, U.S. Pat. No. 4,107,636 to DiGirolamo discloses a plug-in adapter that lowers voltage with an encased transformer. However, the DiGirolamo '636 patent relies on an external transformer adding expense and other electrical components increasing the failure rate of the overall system. The present invention in application does not have any electrical components that would not commonly be found on an already required power cord.

While the above-described devices fulfill their respective, particular objectives and requirements, the aforementioned patents do not describe a simple inexpensive device that when employed, does not increase the over all failure rate of the appliance or electrical device while in operation. Most of these disclosed inventions describe art dependant on an external transformer or other electrical components that have failure rates higher than that of a simple power cord. Also, many of the above-described devices have a selectable switch that will fail due to high “in rush” currents during start up of some electrical devices. Therefore, a need exists for a new and improved universal plug and socket device that can be used for connecting appliances and tools to outlet sockets for higher voltage or lower voltage or different wall socket configurations. In this regard, the present invention substantially fulfills this need. In light of the previous art and current practice, the present invention substantially departs from the conventional concepts and design, and in doing so provides an apparatus simply conceived to elegantly solve an existing problem without complex electrical componentry or circuitry, allowing for trouble free connection of appliances and electrical devices to both 120VAC and 240VAC service outlets.

### SUMMARY OF INVENTION

The present invention provides an improved variable connection device that is simple, inexpensive, reliable, and easy to produce. The present invention is simple, in that it utilizes a universal multi-prong plug and socket that can be configured with different conductive prongs depending on the available electrical service. The present invention is inexpensive, in that most electrical devices require a power plug and cord assembly when connecting to electrical service, so the present invention adds nothing to the manufacturing or production cost. The present invention is reliable, in that the different embodiments are hardwired and encased in nonmetallic insulating material. The embodiments are constructed and arranged using proven methods of power cord manufacturing, making the present invention as reliable as any other commercially available power cord. The present invention is easy to produce due to the simple and elegant design. Any power cord manufacturer can use commercially standard production techniques to build the present invention for any embodiment utilizing the various electrical services available.

### DRAWINGS

### BRIEF DESCRIPTION OF THE DRAWINGS

The proposed invention will be illustrated and better understood concerning the 120VAC/240VAC embodiment set forth below in the detailed description thereof. Such description makes reference to the attached drawings wherein:

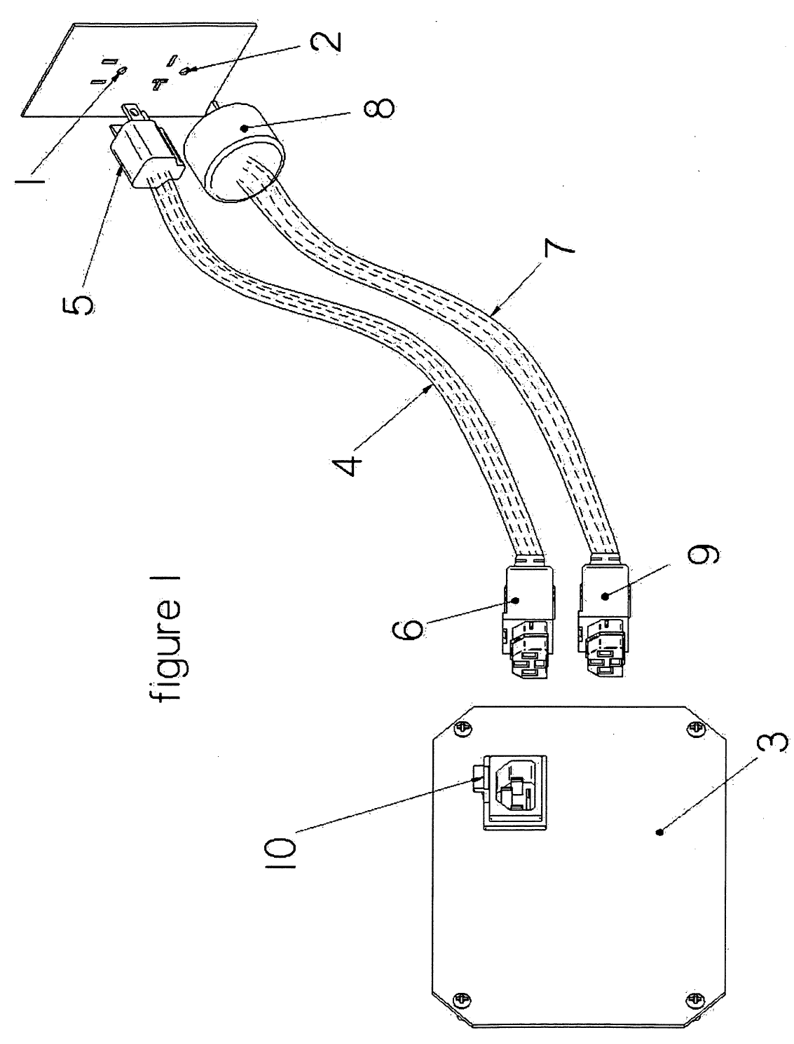

FIG. 1 is an oblique perspective view of the preferred embodiments for both 120VAC and 240VAC, having the universal socket interconnection side and the universal plug interconnection side disengaged. Constructed and arranged in accordance with the principles of the proposed invention, and of the interconnection that the proposed invention makes between a wall socket power source and an electrical device.

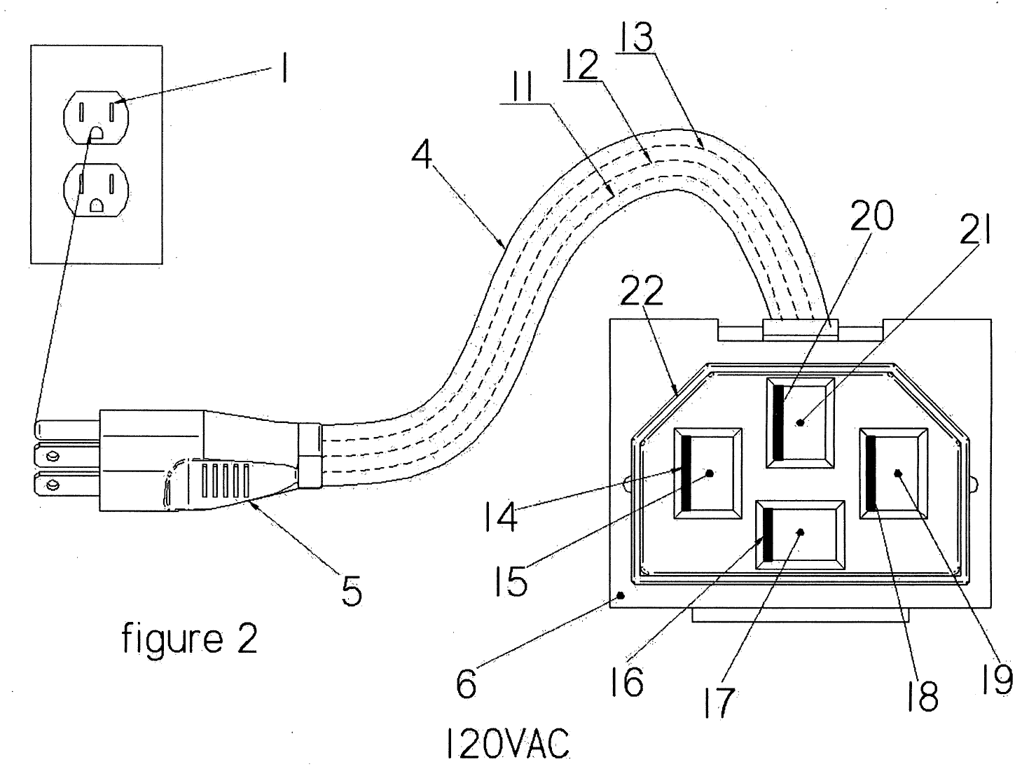

FIG. 2 is a frontal view of the universal plug interconnection side for the 120VAC embodiment of the present invention, demonstrating the conductive prong receptacle cavities and internal conductive terminals.

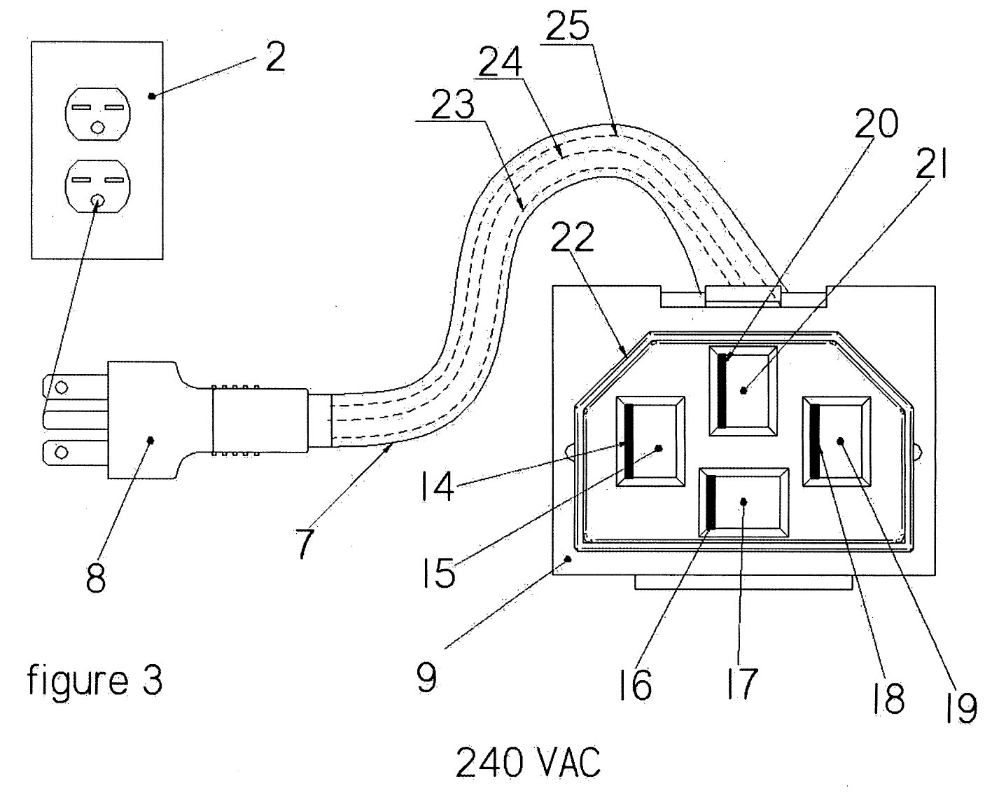

FIG. 3 is a frontal view of the universal plug interconnection side for the 240VAC embodiment of the present invention, demonstrating the conductive prong receptacle cavities and internal conductive terminals.

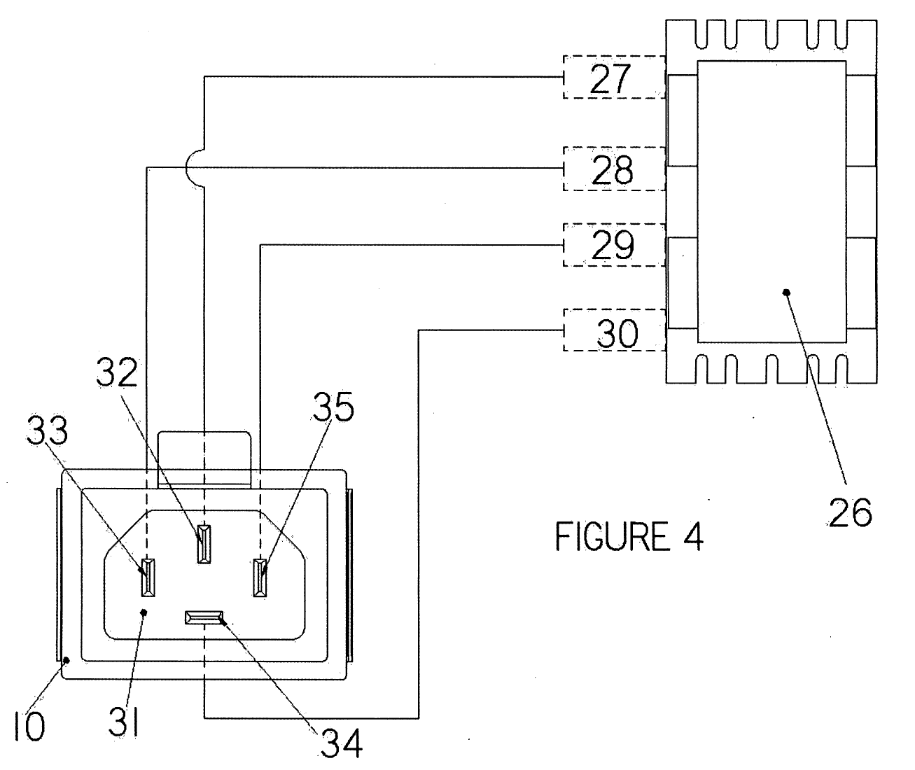

FIG. 4 is a frontal view of the universal socket and wiring configuration to an internal transformer discussed in the embodiment.

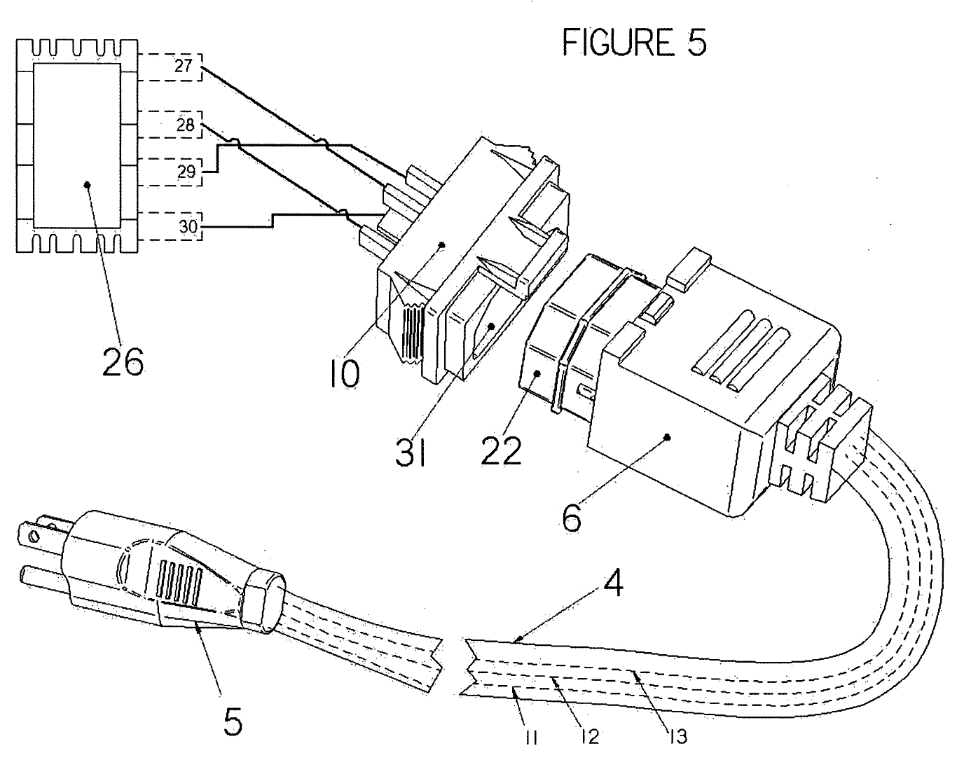

FIG. 5 is a perspective view of the universal socket and universal plug disengaged, including the universal socket wiring configuration to the internal transformer and the 120VAC power cord configuration.

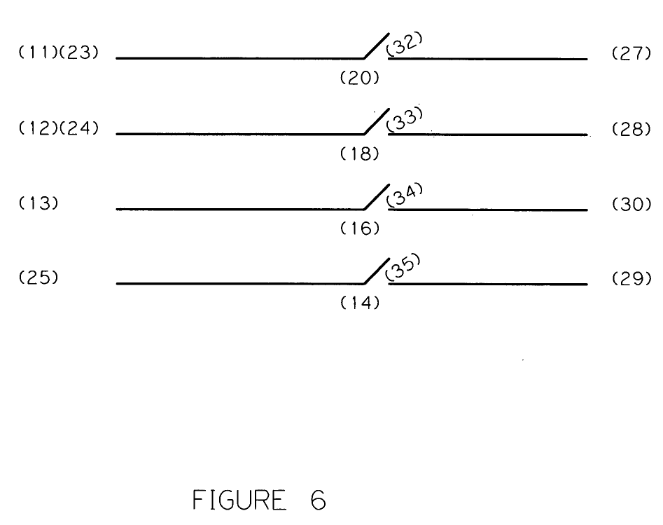

FIG. 6 is an electrical schematic of the electrical connections between electrical service, the universal socket, the universal plug, and the electrical device.

### DESCRIPTION OF THE PREFERRED EMBODIMENTS

Referring now to the drawings, and particularly to FIGS. 1-5, a preferred embodiment of the present invention is shown, illustrating the universal electrical plug and socket configured for use in either a 120VAC or 240VAC service voltage.

Description FIG. 1:

FIG. 1 illustrates one embodiment of the present invention facilitating electrical connection of an electrical device 5, to two different potential service voltages and wall socket configurations, one being 120VAC 1 and the other being 240VAC 2. The 120VAC power cord assembly 4 has on one end a standard 120VAC wall socket plug 3, and on the other end the universal plug 6. The 240VAC power cord assembly 7 has on one end a standard 240VAC wall socket plug 8, and on the other end the universal plug 9. The universal plug 6 and the universal plug 9 are identical, both fittingly insertable into universal socket 10.

Being of simple design and elegant utility, the end user selects the power cord to match the desired or available service voltage and/or wall socket configuration. If 120VAC 1 is the selected power source, the 120VAC power cord assembly 4 is used, the universal plug 6 is inserted into universal socket 10, and the standard 120VAC wall socket plug 5 is plugged into the wall socket 1 to complete connection of electrical service. If 240VAC 2 is the selected power source, the 240VAC power cord assembly 7 is used, the universal plug 9 is inserted into universal socket 10, and the standard 240VAC wall socket plug 8 is plugged into the wall socket 2. For either service voltage or wall socket configuration, the end user performs a simple task that requires no additional skill or effort than installing a standard power cord.

Description FIG. 2:

FIG. 2 shows in greater detail the embodiment of FIG. 1, specifically the 120VAC power cord assembly 4, and conductor wires 120VAC “Ground Leg” 11, 120VAC “Common Leg” 12, and 120VAC “Hot Leg” 13, demonstrating how the wire conductors electrically connect the universal plug 6 with the 120VAC wall socket plug 3. FIG. 2 also illustrates the pentagonal shaped insertable portion 22 of the utility plug 6, including the 240VAC prong receptacle cavity 15, 120 VAC prong receptacle cavity 17, Common prong receptacle cavity 19, Ground prong receptacle cavity 21, with the respective internal conductive terminals “240VAC” 14, “120VAC” 16, “Common” 18, “Ground” 20.

To fully describe how the embodiment shown in FIG. 2 is configured, a brief discussion of standard 120VAC service voltage is appropriate. In the United States, standard 120VAC service voltage is delivered on three legs, the “Ground Leg” 11, the “Common Leg” 12 and the “Hot Leg” 13. The “Ground Leg” 11 and “Common Leg” 12 have no voltage differential between themselves, but the “Common Leg” 12 and “Ground Leg” 11 both have a voltage differential of 120VAC relative to the “Hot Leg” 13. As configured for 120VAC as shown in FIGS. 1 and 2, the 120VAC Power Cord Assembly 4 would be electrically connected as follows: The universal plug 6 would have internal conductor “Ground” 20 hardwired to the “Ground Leg” 11, internal conductor “Common” 18 hardwired to the “Common Leg” 12, and internal conductor“120VAC” 16 hardwired to the “Hot Leg” 13. Internal Conductor “240VAC” 14 is not connected and remains open.

The pentagonal shaped insertable portion 22 is unique among other standard plug shapes and prevents end user error in plugging the unit into some other device or an incorrectly configured power service voltage. The only fitting receiving space for the universal plug 6 is the universal socket 10 shown in FIG. 1. Any other embodiment of the present invention will be uniquely mated by shape between the insertable portion of the plug and the receiving space of the socket.

Description FIG. 3:

FIG. 3 shows in greater detail the embodiment of FIG. 1, specifically the 240VAC power cord assembly 7, and conductor wires 240VAC “Ground Leg” 23, 240VAC “Common Leg” 24, and 240VAC “Hot Leg” 25, demonstrating how the wire conductors electrically connect the universal plug 9 with the 240VAC wall socket plug 8. FIG. 3 also illustrates the pentagonal shaped insertable portion 22 of the utility plug 9, including the 240VAC prong receptacle cavity 15, 120 VAC prong receptacle cavity 17, Common prong receptacle cavity 19, Ground prong receptacle cavity 21, with the respective internal conductive terminals “240VAC” 14, “120VAC” 16, “Common” 18, “Ground” 20. To help illustrate the two different wiring configurations, and considering the universal plug 6 of FIG. 2 and the universal plug 9 of FIG. 3 are identical excepting internal conductor hardwiring, both FIGS. 2 and 3 share the same numeric indicators 14-21.

To fully describe how the embodiment shown in FIG. 3 is figured, a brief discussion of standard 240VAC service voltage is appropriate. In the United States, standard 240VAC service voltage is delivered on three legs, the “Ground Leg” 23, the “Common Leg” 24 and the “Hot Leg” 24. The “Ground Leg” 23 and the “Common Leg” 24 has a voltage differential between themselves of 120VAC. The “Ground Leg” 23 has a voltage differential of 120VAC relative to the “Hot Leg” 25. The 240VAC voltage differential is present between the “Common Leg” 24 and the “Hot Leg” 25. As configured for 240VAC as shown in FIGS. 1 and 3, the 240VAC Power Cord Assembly 7 would be electrically connected as follows: The universal plug 9 would have internal conductor “Ground” 20 hardwired to the “Ground Leg” 23, internal conductor “Common” 18 hardwired to the “Common Leg” 24, and internal conductor “240VAC” 14 hardwired to the “Hot Leg” 25. Internal Conductor “120VAC” 16 is not connected and remains open.

Description FIG. 4:

FIG. 4 illustrates in greater detail the embodiment of FIG. 1, specifically the configuration of the universal socket 10 as wired to an internal transformer 26. The internal transformer 26 is a device commonly found in remote ballast assemblies supporting High Intensity Discharge (HID) lighting. Commonly there are multiple taps or electrical connection points that allow the internal transformer 26 to be wired for several different service voltages. For this embodiment, the internal transformer 26 taps allowing the electrical device to be wired for either 120VAC or 240VAC service voltage will be connected to the universal socket 10. The ground tap 27 electrically connects to conductive prong 32. The common tap 28 electrically connects to conductive prong 33. The 240VAC tap 29 electrically connects to conductive prong 35. The 120VAC tap 30 electrically connects to conductive prong 34.

When universal plug 6 or 9 from FIGS. 1, 2, and 3 are engaged with the universal socket 10, the pentagonal shaped insertable portion 22 is fittingly received in the pentagonal shaped receiver portion 31, conductive prong 35 is fittingly received into the 240VAC prong receptacle cavity 15 and electrically connected to the internal conductor “240VAC” 14, conductive prong 34 is fittingly received into the 120VAC prong receptacle cavity 17 and electrically connected to the internal conductor “120VAC” 16, conductive prong 33 is fittingly received into the “Common” prong receptacle cavity 19 and electrically connected to the internal conductor “Common” 18, conductive prong 32 is fittingly received into the “Ground” prong receptacle cavity 21 and electrically connected to the internal conductor “Ground” 20.

Description FIG. 5:

FIG. 5 illustrates the 120VAC power cord assembly 5 as used in the 120VAC/240VAC embodiment. The pentagonal shaped receiver portion 31 fittingly receives the pentagonal insertable portion 22. As shown in FIGS. 1,2, and 4, conductive prong 35 is fittingly received into the 240VAC prong receptacle cavity 15 and electrically connected to the internal conductor “240VAC” 14, conductive prong 34 is fittingly received into the 120VAC prong receptacle cavity 17 and electrically connected to the internal conductor “120VAC” 16, conductive prong 33 is fittingly received into the “Common” prong receptacle cavity 19 and electrically connected to the internal conductor “Common” 18, conductive prong 32 is fittingly received into the “Ground” prong receptacle cavity 21 and electrically connected to the internal conductor “Ground” 20.

As shown in FIG. 4, for this embodiment the internal transformer 26 taps allowing the electrical device to be wired for either 120VAC or 240VAC service voltage will be connected to the universal socket 10. The ground tap 27 electrically connects to conductive prong 32. The common tap 28 electrically connects to conductive prong 33. The 240VAC tap 29 electrically connects to conductive prong 35. The 120VAC tap 30 electrically connects to conductive prong 34.

As shown in FIGS. 1 and 2, the 120VAC Power Cord Assembly 4 would be electrically connected as follows: The universal plug 6 would have internal conductor “Ground” 20 hardwired to the “Ground Leg” 11, internal conductor “Common” 18 hardwired to the “Common Leg” 12, and internal conductor “120VAC” 16 hardwired to the “Hot Leg” 13. Internal Conductor “240VAC” 14 is not connected and remains open. Having the Internal Conductor “240VAC” 14 unconnected and open also leaves the 240VAC tap 29 electrically unconnected, thus configuring the internal transformer 26 for 120VAC electrical service voltage.

Description FIG. 6:

FIG. 6 illustrates the electrical connections of the plug and socket for both the 120VAC and 240VAC described embodiments. The electrical service “Ground Leg” 11, 23 is electrically connected to the internal conductor for the ground prong receptacle cavity in the plug member 20, when the plug member is fittingly inserted into the socket member the ground prong 20 electrically connects to the ground conductor prong of the socket member 32, which in turn electrically connects the electrical service “Ground” 11, 23 to the ground tap 27 of the internal transformer. The electrical service “Common” 12, 24 is electrically connected to the internal conductor for the common prong receptacle cavity in the plug member 21, when the plug member is fittingly inserted into the socket member, the common prong 21 electrically connects to the common conductor prong of the socket member 33, which in turn electrically connects the electrical service “Common” 12, 24 to the common tap 28 of the internal transformer. This described electrical connection of the “Ground” and “Common” legs are the same for both 120VAC and 240VAC embodiments.

One unique and innovative feature of the present invention is the way in which electrical service connection is facilitated via the 120VAC and 240VAC “Hot Legs” 13, 25. Taking for example the 120VAC embodiment, the electrical service conductor wire 120VAC “Hot Leg” 13 is hardwired to the internal conductor for the 120 VAC prong receptacle 16, inducing electrical connection with the 120 VAC Conductor Prong 34 of the socket member, when the plug member is fittingly inserted into the socket member, resulting in electrical connection of the 120VAC conductor tap 30 to the electrical service conductor wire 120VAC “Hot Leg” 13. Internal conductor for the 240 VAC prong receptacle cavity 14 is not present in the 120 VAC embodiment, thus leaving the 240VAC Tap 29 open and disconnected.

Taking for example the 240VAC embodiment, the electrical service conductor wire 240VAC “Hot Leg” 25 is hardwired to the internal conductor for the 240 VAC prong receptacle 14, inducing electrical connection with the 240 VAC Conductor Prong 35 of the socket member, when the plug member is fittingly inserted into the socket member, resulting in electrical connection of the 240 VAC conductor tap 29 to the electrical service conductor wire 240VAC “Hot Leg” 25. Internal conductor for the 120 VAC prong receptacle cavity 16 is not present in the 240 VAC embodiment, thus leaving the 120VAC Tap 30 open and disconnected.

Those skilled in the art can now appreciate from the foregoing description that the broad teachings of the present invention can be implemented in many electrical power service voltages and wall socket configurations. Therefore, while this invention has been described in detailed as a 120VAC/240VAC adapter, the true scope of the invention should not be limited since the modifications and apparent applications become obvious to the skilled practitioner upon complete review of the drawings, descriptions, and the following claims.

1. A socket and plug assembly, comprising:
a socket member including a housing that confines a plug receiver space and defining an axial direction, said socket member further including a socket face plate internal to the housing and perpendicular to the axial direction defining the depth of the plug receiver space, further including at least four conductive prongs mounted through and projecting outwardly from said socket face into said plug receiver space, said conductive prongs also extending oppositely in the axial direction through the non-conductive housing, said conductive prong ends extending out through said non-conducting housing permitting electrical connection to an electrical device; and
a plug member fittingly insertable into said receiver space of said mated socket member, including a non-conducting plug case having a plug face side and a power cord side, further including at least four prong cavities open on the plug face side being in spatial communication with the number, fit, and configuration of said conductive prongs protruding from said socket face plate, including one or more internal conductive terminals captively connected within said prong cavities, said internal conductive terminals being conductively exposed inside the prong cavities, constructed and arranged to induce electrical connection with said conductive prongs when said conductive prongs are received into said prong cavities, said internal conductive terminals projecting outwardly from the non-conducting plug case along the axial direction on the power cord side permitting electrical connection between the internal conductive terminals and a power cord.

2. The plug member according to claim 1 wherein said internal conductive terminals are mounted in all but one of said prong cavities, said prong cavity not having said internal conductive terminal is non-conductive and insulating for any conductive prong inserted.

3. The plug member according to claim 1 wherein each of said prong cavities have at least one internal conductive terminals captively connected within said prong cavities, further including at least one internal conductive terminal capped or covered in non-conducting material on the power cord side preventing said capped terminal from being connected to a power cord.

4. The socket and plug assembly according to claim 1 wherein said conductive prongs are electrically connected to a power cord, and said internal conductive terminals are electrically connected to an electrical device.

5. The socket and plug assembly according to claim 1 wherein said receiver plug space is defined by a pentagonal shape perpendicular to the axial direction, further including said plug member defined by a pentagonal shape, wherein said plug member fittingly inserts into said receiver plug space.

6. The socket and plug assembly according to claim 1 wherein said plug is connected to one end of a power cord, further comprising said socket connected to the other end of said power cord.
